(19) United States
(12) Patent Application Publication
(10) Pub. No.: US 2026/0189120 A1
(43) Pub. Date: Jul. 2, 2026

(54) MOTOR DIRECT-COUPLED AUTOMATIC MAGNETIC RELEASE DEVICE

(71) Applicants: Seung Ho JUNG, Incheon (KR); MMPENG CO., LTD., Siheung-si, Gyeonggi-do (KR)

(72) Inventor: Seung Ho JUNG, Incheon (KR)

(73) Assignees: Seung Ho JUNG, Incheon (KR); MMPENG CO., LTD., Siheung-si, Gyeonggi-do (KR)

(21) Appl. No.: 18/728,068

(22) PCT Filed: May 10, 2023
(86) PCT No.: PCT/KR2023/006319

§ 371 Date: Jul. 10, 2024

(30) Foreign Application Priority Data
Mar. 3, 2023 (KR) 10-2023-0028471

(51) Int. Cl. H02K 49/10

(52) U.S. Cl. CPC H02K 49/108

(57) ABSTRACT

The present invention relates to a motor direct-coupled automatic magnetic release device, and a purpose of the present invention provides a motor direct-coupled automatic magnetic release device in which a motor shaft is directly coupled to an output shaft of a drive motor, a rotor and an impeller provided with permanent magnets may rotate by power of the motor shaft, the rotor is lowered from a step surface of the motor shaft to prevent damage to the impeller or the like when a magnetic force is released, the rotor is raised using a lever through a slot formed on an outer surface of a motor housing, and a rapid attractive force may be prevented from being applied.

### TECHNICAL FIELD

The present invention relates to a motor direct-coupled automatic magnetic release device, and more particularly, to a motor direct-coupled automatic magnetic release device in which a motor shaft is directly coupled to an output shaft of a drive motor, a rotor and an impeller provided with permanent magnets may rotate by power of the motor shaft, the rotor is lowered from a step surface of the motor shaft to prevent damage to the impeller or the like when a magnetic force is released, the rotor is raised using a lever through a slot formed on an outer surface of a motor housing, and a rapid attractive force may be prevented from being applied.

### BACKGROUND ART

Generally, a mixing device using a stirring blade such as an impeller is used to stir a liquid mixture in a stirring container including a reaction fermentation tank or a microbial culture tank.

In this mixing device, since sizes of a motor and a gearbox are increased to correspond to a capacity of the stirring container, an upper portion of the stirring container has an unnecessary space, and a lifting device such as a crane is required when the mixing device is separated from the stirring container for repair or replacement. Thus, mixing devices using a magnet are widely used.

That is, a magnetic mixing device having a structure in which a rotor provided with a magnet is mounted on one end of an output shaft of the motor, the impeller equipped with a magnet is seated on the rotor, and thus the impeller is fixed and rotated by a magnetic force is used.

However, since a magnetic mixing device according to the related art uses a strong magnetic force magnet to fix the impeller on the rotor, when there is a change in a magnetic force due to continuous use, a bearing may be damaged or loosened, and the impeller may be separated or rotation of the impeller may be not measured.

In order to solve this problem, the applicant has previously registered a magnetic mixing device of Korean Patent Registration No. 10-2097059.

In the above technical description, the mixing device includes a shaft passing through a drive motor unit and rotatably coupled to the drive motor unit, a first housing coupled to one side of the drive motor unit, provided outside a stirring container, and accommodating an upper portion of the shaft, a rotating rotor coupled to a distal end of the shaft at the stirring container during a normal operation and provided with a first permanent magnet, and an impeller unit disposed inside the stirring container and provided with a second permanent magnet magnetically coupled to the first permanent magnet during the normal operation, wherein the first housing is provided with a magnetic release rotating rotor support part that protrudes inward and supports the rotating rotor, which is down-driven and moves downward of the shaft, from below when magnetic release in which magnetic coupling is released due to magnetic deformation of at least one of the first permanent magnet and the second permanent magnet occurs.

However, in the magnetic mixing device according to the related art, the shaft is rotatably coupled to the drive motor unit, and is mounted on a reducer installed to reduce a rotational speed or change a rotational direction of the shaft, and there is a problem that the shaft may not be directly coupled to an output shaft of a motor without the reducer.

That is, when the shaft is directly coupled to the output shaft of the motor, it is difficult to secure a space for lowering the rotor, and even when the space for the lowered rotor is secured, it is difficult to implement a structure that may raise the lowered rotor.

### DISCLOSURE

### Technical Problem

The present invention is intended to solve the problems of the related art, and a purpose of the prevent invention provides a motor direct-coupled automatic magnetic release device in which a motor shaft is directly coupled to an output shaft of a drive motor, a rotor and an impeller provided with permanent magnets may rotate by power of the motor shaft, the rotor is lowered from a step surface of the motor shaft to prevent damage to the impeller or the like when a magnetic force is released, the rotor is raised using a lever through a slot formed on an outer surface of a motor housing, and a rapid attractive force may be prevented from being applied.

### Technical Solution

As the technical spirit for achieving the present invention, a motor direct-coupled automatic magnetic release device includes a drive motor having a motor bracket coupled around an output shaft, a motor housing having a lower flange fixed to the motor bracket and having at least one slot of which an inside and an outside are through and which is formed on a side surface thereof, a motor shaft which is positioned inside the motor housing, of which a lower portion is key-coupled to the output shaft, and in which a shaft bolt is coaxially coupled to the output shaft at an upper end thereof, and a stepped surface is formed on an outer circumference thereof, a welding plate in which the lower flange is screw-coupled to an upper flange of the motor housing, a protrusion cap protrudes upward to form a space thereinside, and the lower flange is fixed to a stirring container, a rotor coupled to the space of the welding plate, having an inner circumference axially coupled to the stepped surface of the motor shaft, and having a first permanent magnet installed at an upper end thereof, and an impeller coupled to an outside of the space of the welding plate, having a second permanent magnet corresponding to the first permanent magnet and installed therein, and having a bearing part formed at an upper portion thereof and installed rotatably, wherein power of the drive motor rotates the motor shaft, the rotor, and the impeller through the output shaft, and when magnetic release occurs in the first permanent magnet of the rotor and the second permanent magnet of the impeller, the inner circumference of the rotor falls downward along the stepped surface of the motor shaft.

Further, when the rotor in which the magnetic release occurs is recoupled, a lever may be coupled to a screw hole formed on an outer surface of the rotor through the slot of the motor housing to raise the rotor.

Further, the slot of the motor housing may be formed in an arc shape from a lower left end to an upper right end of a cylindrical surface and, may be equally formed on left and right sides, to prevent rapid adsorption between the rotor and the impeller.

### Advantageous Effects

As the technical spirit for achieving the present invention, in a motor direct-coupled automatic magnetic release device according to the present invention, a motor shaft is directly coupled to an output shaft of a drive motor, a rotor and an impeller provided with permanent magnets may rotate by power of the motor shaft, the rotor is lowered from a stepped surface of the motor shaft when a magnetic force is released, the rotor is raised through a slot formed on an outer surface of a motor housing, an attractive force may be applied, and thus damage to the impeller, the bearing, and the like may be prevented.

### DESCRIPTION OF DRAWINGS

FIG. 1 is a cross-sectional view illustrating a stirring device to which a motor direct-coupled automatic magnetic release device is applied according to the present invention.

FIG. 2 is an exploded perspective view of the motor direct-coupled automatic magnetic release device according to the present invention.

FIG. 3 is an exploded cross-sectional view of the motor direct-coupled automatic magnetic release device according to the present invention.

FIG. 4 is a coupled cross-sectional view of the motor direct-coupled automatic magnetic release device in a state in which a magnetic force is applied to an impeller and a rotor according to the present invention.

FIG. 5 is a coupled cross-sectional view of the motor direct-coupled automatic magnetic release device in a state in which the magnetic force is released from the impeller and the rotor according to the present invention.

FIG. 6 is a view illustrating a coupling relationship between the rotor and a motor shaft of the motor direct-coupled automatic magnetic release device, wherein FIG. 6A is a cross-sectional view in an exploded state, FIG. 6B is a cross-sectional view in a state in which power is transmitted, and FIG. 6C is a cross-sectional view in a state in which power is cut off.

FIG. 7 is a plan view of a state in which a lever is coupled to a slot in the motor direct-coupled automatic magnetic release device according to the present invention.

FIG. 8 is a view illustrating a shape of a slot of a motor housing in the motor direct-coupled automatic magnetic release device according to the present invention.

### MODES OF THE INVENTION

Advantages and features of the present invention and a method of achieving the advantages and the features will become apparent with reference to embodiments described below in detail together with the accompanying drawings. However, the present invention is not limited to the embodiments described below but will be implemented in various forms, and the present embodiments merely make the invention of the present invention complete, are provided to completely inform the scope of the present invention to those skilled in the art to which the present invention belongs, and are defined by the description of the appended claims.

Meanwhile, terms used in the present specification are intended to describe the embodiments and are not intended to limit the present invention. In the specification, a singular form also includes a plural form unless specifically mentioned in a phrase. The term “comprise” or “comprising” used herein means that the presence or addition of one or more other components, steps, operations, and/or elements are not excluded to components, steps, operations, and/or elements described above. Hereinafter, embodiments of the present invention will be described in detail with reference to the accompanying drawings.

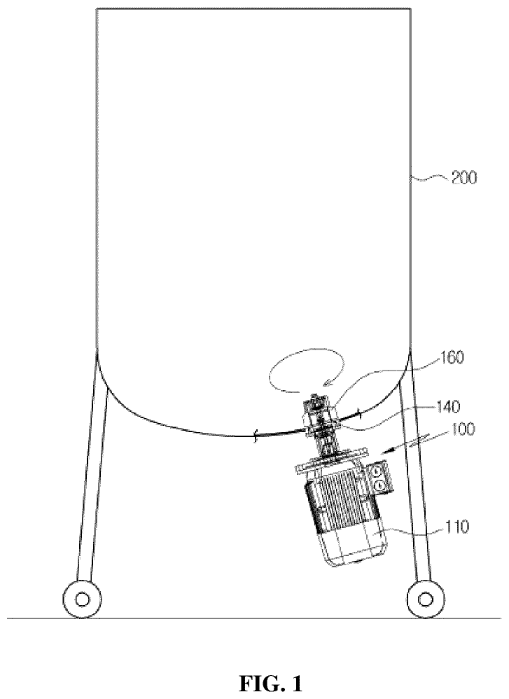

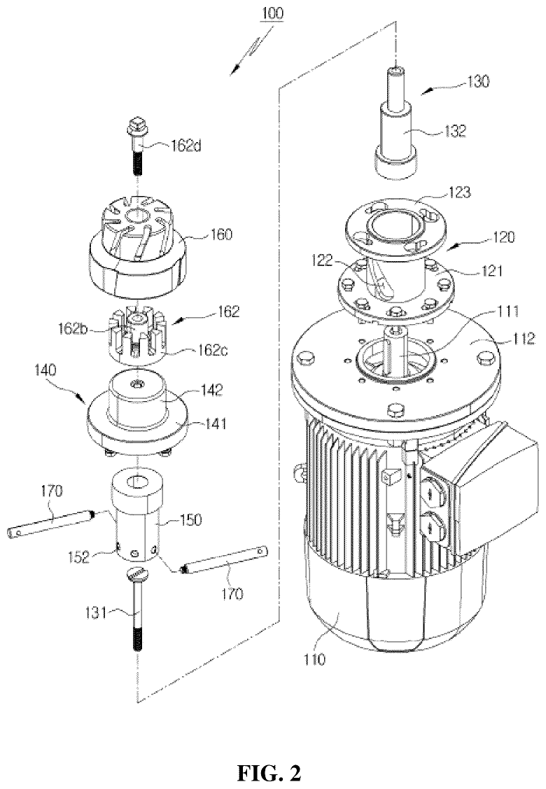

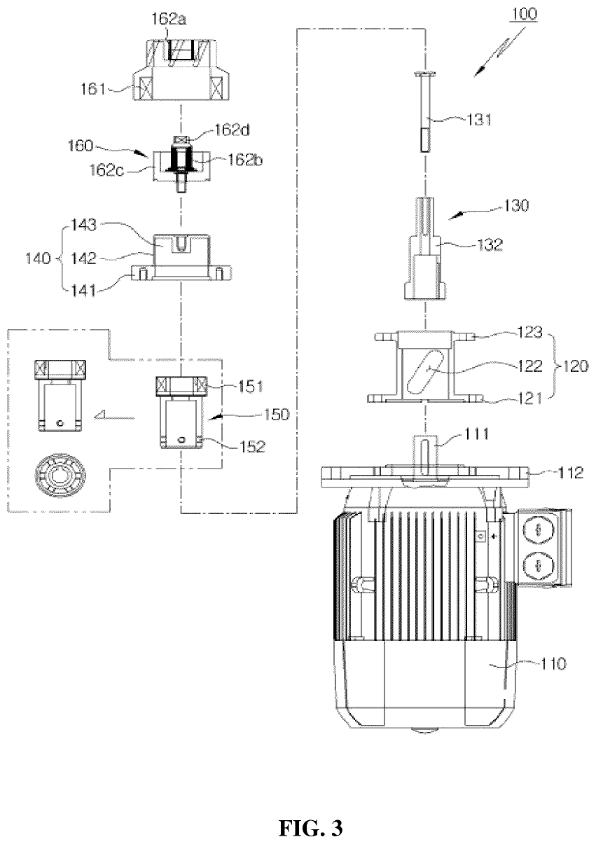

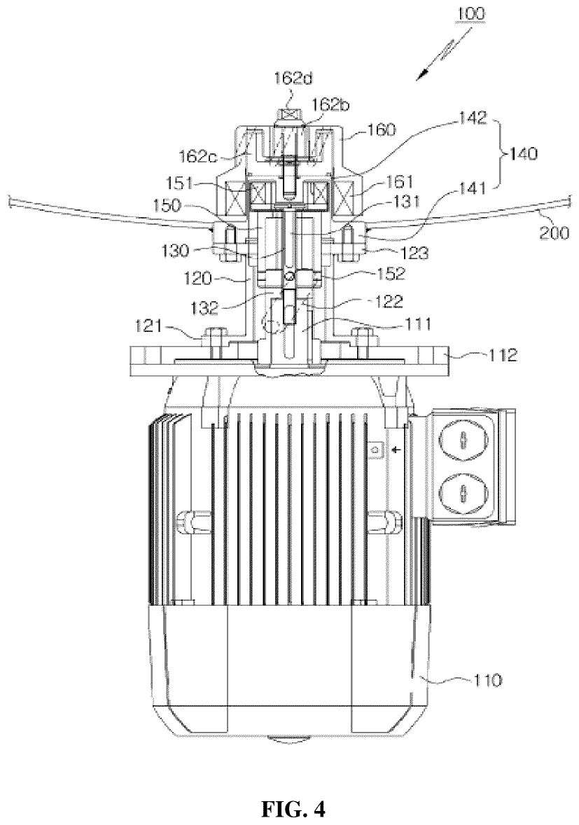

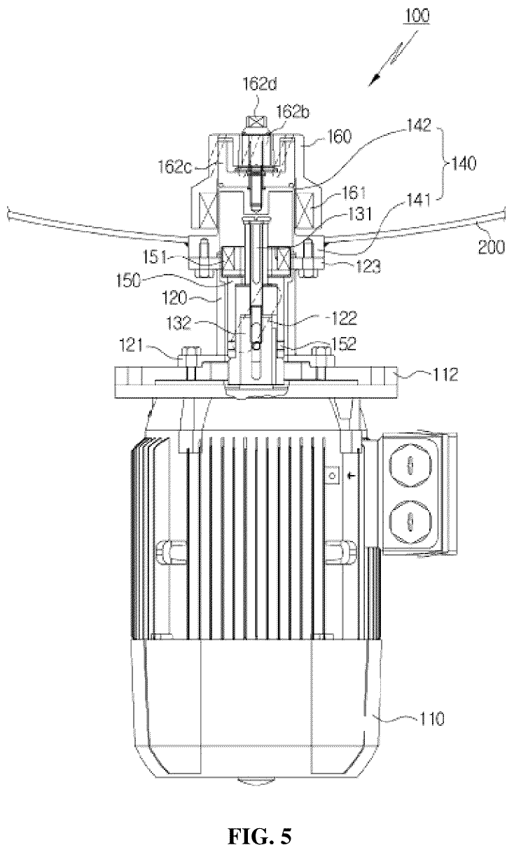

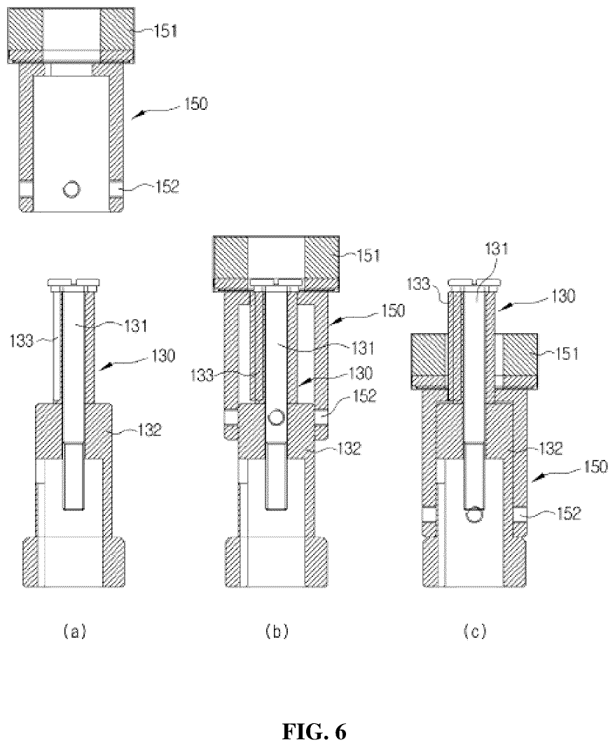

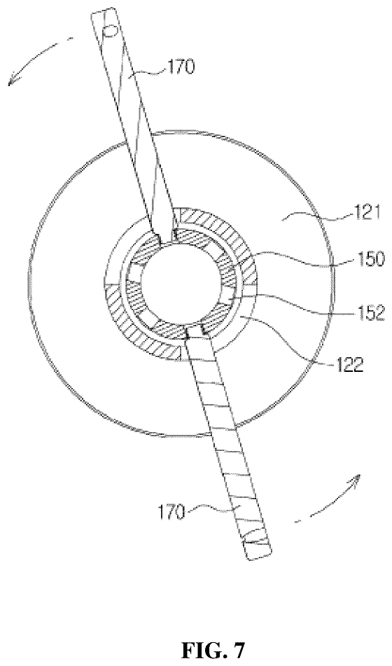

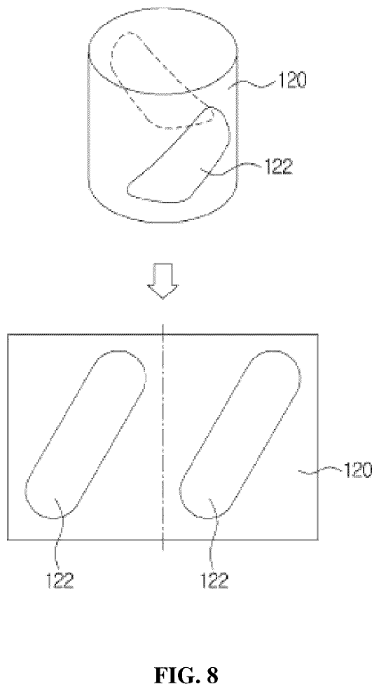

FIG. 1 is a cross-sectional view illustrating a stirring device to which a motor direct-coupled automatic magnetic release device is applied according to the present invention, FIG. 2 is an exploded perspective view of the motor direct-coupled automatic magnetic release device according to the present invention, FIG. 3 is an exploded cross-sectional view of the motor direct-coupled automatic magnetic release device according to the present invention, FIG. 4 is a coupled cross-sectional view of the motor direct-coupled automatic magnetic release device in a state in which a magnetic force is applied to an impeller and a rotor according to the present invention, FIG. 5 is a coupled cross-sectional view of the motor direct-coupled automatic magnetic release device in a state in which the magnetic force is released from the impeller and the rotor according to the present invention, and FIG. 6 is a view illustrating a coupling relationship between the rotor and a motor shaft of the motor direct-coupled automatic magnetic release device, wherein FIG. 6A is a cross-sectional view in an exploded state, FIG. 6B is a cross-sectional view in a state in which power is transmitted, and FIG. 6C is a cross-sectional view in a state in which power is cut off. FIG. 7 is a plan view of a state in which a lever is coupled to a slot in the motor direct-coupled automatic magnetic release device according to the present invention, and FIG. 8 is a view illustrating a shape of a slot of a motor housing in the motor direct-coupled automatic magnetic release device according to the present invention.

Referring to FIGS. 1 to 8, a motor direct-coupled automatic magnetic release device 100 according to the present invention constitutes a mixing device for stirring contents inside a stirring container 200 and includes a drive motor 110, a motor housing 120, a motor shaft 130, a welding plate 140, a rotor 150, and an impeller 160.

The drive motor 110 has a motor bracket 112 coupled to around an output shaft 111 and generates power by supplying of electricity.

The motor housing 120 has a lower flange 121 fixed to the motor bracket 112, and at least one slot 122 of which an inside and an outside are through is formed on a side surface of the motor housing 120.

Further, an upper flange 123 is formed on the motor housing 120, and a welding plate 140, which will be described below, is coupled thereto.

Further, the slot 122 of the motor housing 120 is formed in an arc shape from a lower left end to an upper right end of a cylindrical surface, is equally formed on left and right sides, and thus prevents rapid adsorption between the rotor 150 and the impeller 160.

Further, it is preferable that the slot 122 of the motor housing 120 be formed in the arc shape from the lower left end to the upper right end of the cylindrical surface, be equally formed on the left and right sides, and thus prevent the rapid adsorption between the rotor 150 and the impeller 160 (see FIG. 8).

That is, when a magnetic force formed between the rotor 150 and the impeller 160 is released and the impeller 160 and the rotor 150 are separated from each other, a lever 170 is coupled to a lower left end of the slot 122 for recoupling. Therefore, the lever 170 may be fixed to a screw hole 152 of the rotor 150, the rotor 150 may move upward along the arc-shaped slot 122 using the lever 170, the magnetic force occurs between the rotor 150 and the impeller 160 in a middle portion of the slot 122, and thus the rotor 150 may be gradually adsorbed to the impeller 160.

The motor shaft 130 is positioned inside the motor housing 120 and has a lower portion that is key-coupled to the output shaft 111, a shaft bolt 131 is coaxially coupled to the output shaft 111 at an upper end thereof, and a stepped surface 132 is formed in an outer circumference.

In the welding plate 140, a lower flange 141 is screw-coupled to the upper flange 123 of the motor housing 120, a protrusion cap 142 protrudes upward to form a space 143 therein, and the lower flange 141 is fixed to the stirring container 200.

Further, a screw hole is formed in an upper side of the protrusion cap 142, and a bearing bolt 162d, which will be described below, is coupled thereto.

It is preferable that the lower flange 141 be fixed to the stirring container 200 by welding, but the present invention is not limited thereto, and the lower flange 141 may be installed on the stirring container 200 using a sealing member by widely known fastening means such as bolts or nuts.

The rotor 150 is coupled to the space 143 of the welding plate 140, an inner circumference thereof is axially coupled to the stepped surface 132 of the motor shaft 130, and a first permanent magnet 151 is installed at an upper end thereof.

Further, the rotor 150 and the motor shaft 130 are coupled using a fastening key 133 to enable power transmission (see FIG. 6).

Further a plurality of screw holes 152 to which the lever 170 is coupled are formed at a lower end of the rotor 150.

Further, when the rotor 150, from which the magnetic force is released, is recoupled, the lever 170 is coupled the screw hole 152 formed on an outer surface of the rotor 150 through the slot 122 of the motor housing 120 to raise the rotor 150 (see FIG. 7).

The lever 170 manually raises or lowers the rotor 150 and separates the rotor 150 when the impeller 160 rotates.

The impeller 160 is coupled to an outside of the protrusion cap 142 of the welding plate 140, a second permanent magnet 161 corresponding to the first permanent magnet 151 is installed therein, a bearing part 162 is formed thereon, and thus the impeller 160 is rotatably installed.

The bearing part 162 includes a female bearing 162a fixed to an upper through-hole of the impeller 160, a male bearing 162b coupled to the female bearing 162a, a stator 162c which is coupled to an inner upper side of the impeller 160 and to which the male bearing 162b is coupled with a washer, and the bearing bolt 162d passing through the male bearing 162b and the stator 162c and fixed to an upper portion of the welding plate 140.

The motor direct-coupled automatic magnetic release device 100 according to the present invention as configured above is installed below the stirring container 200, a through-hole is perforated in the stirring container 200, and the lower flange 141 of the welding plate 140 is positioned in the through-hole and fixed by welding or the like.

The protrusion cap 142 installed inside the stirring container 200 is positioned on the welding plate 140, and the impeller 160 in which the second permanent magnet 161 is formed is rotatably coupled to an upper portion of the protrusion cap 142.

The stator 162c is coupled to an inside of the impeller 160, the male bearing 162b installed inside the stator 162c and the female bearing 162a installed on the impeller 160 are coupled to each other, and the bearing bolt 162d passes through the male bearing 162b and the stator 162c and is fixed to the screw hole on the protrusion cap 142.

The rotor 150 or the drive motor 110 is coupled to a lower portion of the welding plate 140.

First, the lower portion of the motor shaft 130 is key-coupled to the output shaft 111 of the drive motor 110, and the upper end of the motor shaft 130 is coaxially coupled to the output shaft 111 with the shaft bolt 131.

A lower portion of the rotor 150 is positioned on a stepped surface of the motor shaft 130, the lower flange 121 of the motor housing 120 is coupled to the motor bracket 112 coupled around the output shaft 111, and the upper flange 123 of the motor housing 120 is screw-coupled to a lower surface of the welding plate 140.

As described above, a state in which the impeller 160 and the rotor 150 are coupled to upper and lower sides of the welding plate 140 is a state in which an attractive force is not applied, a user manually couples a pair of levers 170 to lower screw holes of the rotor 150 through the slots 122 on both sides of the motor housing 120, and when the rotor 150 is raised along the slots 122 using the levers 170, an attractive force is applied between the impeller 160 and the rotor 150 in a middle portion of the slot 122, thereby preventing rapid adsorption.

Further, the lever 170 should be removed when the attractive force is applied to the rotor 150 and the impeller 160.

In this state, when power is applied to the drive motor 110, the power of the output shaft 111 rotates the motor shaft 130, the rotor 150, and the impeller 160, and thus contents of the stirring container 200 may be stirred by the impeller 160.

Magnetic release occurs due to various reasons in the impeller 160 normally operating. When the magnetic release occurs, the rotor 150 falls downward from the stepped surface of the motor shaft 130, thereby blocking a magnetic force. (For reference, the magnetic release includes magnetic release due to dry run, magnetic release due to excessive swirling, magnetic release during stirring in a state in which washing is not performed, magnetic release due to collision with a person in the stirring container, magnetic release due to foreign matters caught in the bearing, and magnetic release during reverse rotation)

A ceramic bearing according to the related art may be broken due to an impact during stirring or maintenance, but when the magnetic release occurs as described above, this problem is prevented.

Further, damage to the impeller 160, the welding plate 140, and the stator 162c due to foreign substances in the bearing or foreign substances generated during stirring being caught in components or the like may be prevented.

Further, damage to the bearing as the impeller 160 is shaken and damage to a screw thread or a fastening part as the bearing bolt 162d pressing the bearing is loosened may be prevented.

Further, when the magnetic release occurs, the impeller 160 may be prevented from being separated into the stirring container 200 during the stirring and causing damage to the stirring container 200 by a rotating force and magnetic forces pushing each other.

Meanwhile, because a magnetic mixer according to the related art is not vertically mounted in a center but mounted at an angle, when an operation is performed without separating a drive unit (drive motor), it is difficult to correctly mount the impeller due to a magnetic pulling force, and damage to components and an injury of a worker may occur. Thus, the drive unit of the stirring container is separated and then the impeller and the bearing are inspected, but the motor direct-coupled automatic magnetic release device according to the present invention may manually perform the magnetic release. This is achieved by coupling the lever to the screw hole of the rotor through the slot of the motor housing and lowering the lever from an upper right end to a lower left end.

Accordingly, in the present invention, the magnetic release is manually performed, and thus the impeller and the bearing may be inspected without separating the drive unit of the stirring container.

The present invention has been described with reference to an embodiment illustrated in the accompanying drawings, but it will be understood by those skilled in the art that various modifications and other embodiments are possible.

1. A motor direct-coupled automatic magnetic release device comprising:
a drive motor having a motor bracket coupled around an output shaft;
a motor housing having a lower flange fixed to the motor bracket and having at least one slot that passes through from an inside and outside thereof and is formed on a side surface thereof;
a motor shaft which is positioned inside the motor housing, of which a lower portion is key-coupled to the output shaft, and in which a shaft bolt is coaxially coupled to the output shaft at an upper end thereof, and a stepped surface is formed on an outer circumference thereof;
a welding plate in which the lower flange is screw-coupled to an upper flange of the motor housing, a protrusion cap protrudes upward to form a space thereinside, and the lower flange is fixed to a stirring container;
a rotor coupled to the space of the welding plate, having an inner circumference axially coupled to the stepped surface of the motor shaft, and having a first permanent magnet installed at an upper end thereof; and
an impeller coupled to an outside of the space of the welding plate, having a second permanent magnet corresponding to the first permanent magnet and installed therein, and having a bearing part formed at an upper portion thereof and installed rotatably,
wherein power of the drive motor rotates the motor shaft, the rotor, and the impeller through the output shaft, and when magnetic release occurs in the first permanent magnet of the rotor and the second permanent magnet of the impeller, the inner circumference of the rotor falls downward along the stepped surface of the motor shaft.

2. The motor direct-coupled automatic magnetic release device of claim 1, wherein when the rotor in which the magnetic release occurs is recoupled, a lever is coupled to a screw hole formed on an outer surface of the rotor through the slot of the motor housing to raise the rotor.

3. The motor direct-coupled automatic magnetic release device of claim 2, wherein the slot of the motor housing is formed in an arc shape from a lower left end to an upper right end of a cylindrical surface, and is equally formed on left and right sides, to prevent rapid adsorption between the rotor and the impeller.
